(19) United States
(12) Patent Application Publication
(10) Pub. No.: US 2015/0347570 A1
(43) Pub. Date: Dec. 3, 2015

(54) CONSOLIDATING VOCABULARY FOR AUTOMATED TEXT PROCESSING

(71) Applicant: General Electric Company, Schenectady, NY (US)

(72) Inventors: Kalpit Vikrambhai Desai, Bangalore (IN); Gopi Subramanian, Bangalore (IN)

(73) Assignee: General Electric Company, Schenectady, NY (US)

(21) Appl. No.: 14/289,279

(22) Filed: May 28, 2014

(51) Int. Cl. G06F 17/30; G06F 17/21

(52) U.S. Cl. CPC G06F 17/30666; G06F 17/21

(57) ABSTRACT

A method includes providing a corpus of text, and using suffix manipulation to obtain a stem for at least some tokens in the corpus. The method also includes using the respective stem for each token of the at least some tokens to form groups of the at least some tokens. In addition, the method includes using the groups of tokens to select lemmas for at least some of the tokens in the groups of tokens.

### BACKGROUND

1. Technical Field

Embodiments of the invention relate to data mining and analyses of text corpuses.

2. Discussion of Art

Free-form text usually requires several preprocessing steps to make it amenable to automated processing by computer algorithms. One well-known preprocessing step is referred to as “vocabulary consolidation”. The latter term generally refers to the process of mapping various related word forms (e.g., plurals, nouns, verbs, adverbs, etc.) to an appropriate base-form. Vocabulary consolidation may enhance the effectiveness of text-mining processes such as word-counting, as the effectiveness of a word-counting process may be adversely affected if related word-variants are considered separately. In addition, vocabulary consolidation may compress the corpus prior to analysis, thereby promoting enhanced efficiency of text mining algorithms.

Conventional approaches to vocabulary consolidation can be broadly classified into two groups—suffix manipulation and lemmatization. Suffix manipulation algorithms typically are based on a set of rules for a given language. According to these rules suffixes of words in the corpus are removed or modified to collapse variations in suffixes to the word's base-form. This process is often referred to as “stemming”. (The term “stemming” will be used in that sense in this document, i.e., as a synonym for suffix manipulation processing; it will not be used in the alternative sense which encompasses the broader task of vocabulary consolidation generally.)

Lemmatization is the process of determining the “lemma” for a given word, where a “lemma” is the base-form for a word that exists in a dictionary. Some lemmatization processes first determine the part-of-speech (POS) for the word under consideration for lemmatization, but a desire for scalability in the processing algorithm may lead to simplifying assumptions about the word's POS.

One disadvantage of suffix manipulation is that it often produces a base-form that is not a valid dictionary word (e.g., “vibrat” as a base-form for “vibrates”, “vibrated”, “vibrating”). One disadvantage of lemmatization is that it produces a lower degree of vocabulary consolidation than suffix manipulation.

The present inventors have now recognized opportunities to synergistically combine suffix manipulation with lemmatization to provide improved vocabulary consolidation processing.

### BRIEF DESCRIPTION

In some embodiments, a method includes providing a corpus of text, and using suffix manipulation to obtain a stem for at least some tokens in the corpus. The method also includes using the respective stem for each token of the at least some tokens to form groups of the at least some tokens. In addition, the method includes using the groups of tokens to select lemmas for at least some of the tokens in the groups of tokens.

In some embodiments, an apparatus includes a processor and a memory in communication with the processor. The memory stores program instructions, and the processor is operative with the program instructions to perform functions as set forth in the preceding paragraph.

### BRIEF DESCRIPTION OF THE DRAWINGS

FIG. 1 is a block diagram of a computing system according to some embodiments.

FIG. 2 is a block diagram that illustrates some details of the computing system of FIG. 1.

FIG. 3 is a flow diagram of an operation according to some embodiments.

FIG. 4 is a flow diagram of an operation according to other embodiments.

FIG. 5 is a flow diagram of an operation according to still other embodiments.

FIG. 6 is a flow diagram that shows some details of the operation of FIG. 5.

FIG. 7 is a flow diagram that shows some other details of the operation of FIG. 5.

FIG. 8 is a flow diagram that shows some details of the operation of FIG. 7.

FIG. 9 is a flow diagram that shows still other details of the operation of FIG. 5.

FIG. 10 is a flow diagram that shows some details of the operation of FIG. 9.

FIG. 11 is a block diagram of a computing system according to some embodiments.

### DESCRIPTION

Some embodiments of the invention relate to data mining and text processing, and more particularly to preprocessing of corpuses of text. Stemming may be applied to the words in the corpus, and the resulting stems may be used to group the words. The groupings, in turn, may be used to aid in selecting lemmas for the words.

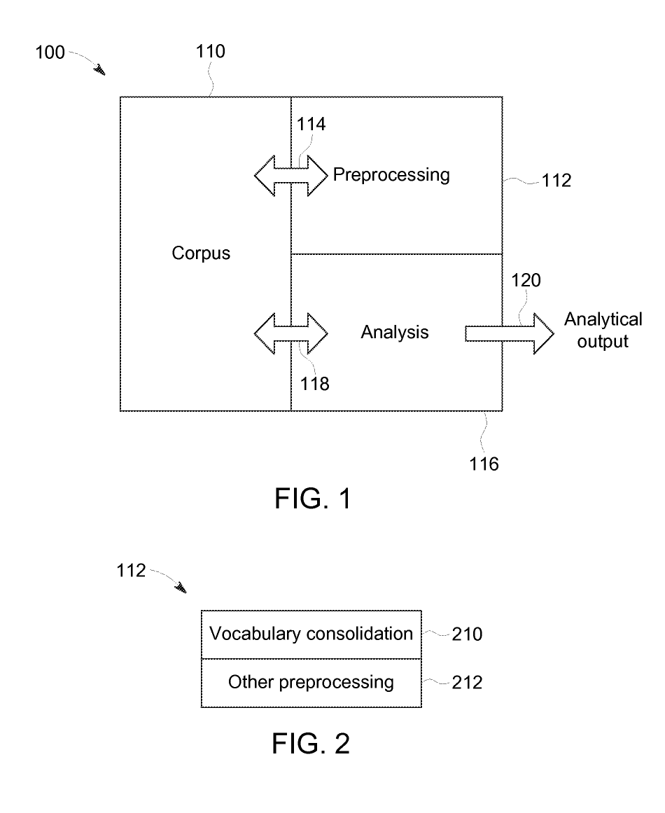

FIG. 1 represents a logical architecture for describing systems, while other implementations may include more or different components arranged in other manners. In FIG. 1, a system 100 includes a corpus 110 of text to be analyzed; the corpus 110 may be stored in a data storage device (not separately shown in FIG. 1), which may include any one or more data storage devices that are or become known. Examples of data storage device include, but are not limited to, a fixed disk, an array of fixed disks, and volatile memory (e.g., Random Access Memory).

Block 112 in FIG. 1 represents preprocessing functionality of the system 100. As indicated at 114, the preprocessing functionality 112 of the system 100 may be applied to the corpus 110. Block 116 in FIG. 1 represents analytical/text mining functionality of the system 100. As indicated at 118, the analytical/text mining functionality 116 of the system 100 may also be applied to the corpus 110. This may occur after preprocessing of the corpus 110. The analytical/text mining functionality 116 of the system 100 may output desired analytical results, as indicated at 120 in FIG. 1. The functionality represented by blocks 112 and 116 may be implemented via one or more computing devices (not separately shown in FIG. 1) executing program code to operate as described herein.

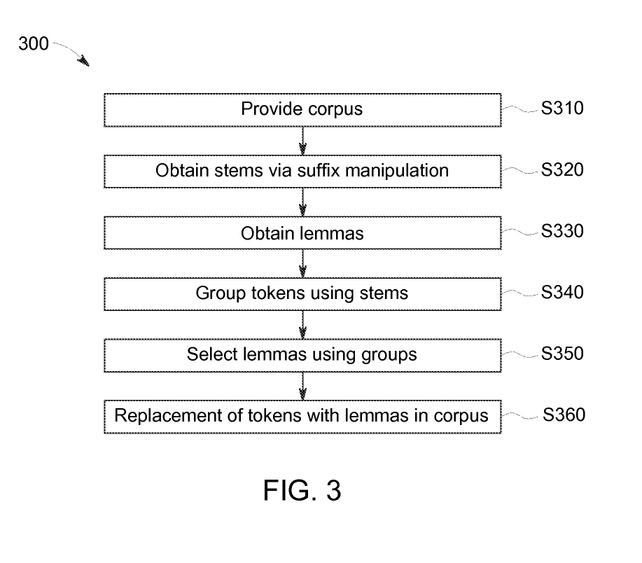

FIG. 2 is a block diagram that illustrates some details of the system 100. More specifically, FIG. 2 illustrates aspects of the preprocessing functionality 112 of system 100. In some embodiments, the preprocessing functionality 112 includes vocabulary reduction processing 210 and other preprocessing 212. It should be noted that some preprocessing steps may occur before vocabulary reduction processing and others may occur after vocabulary reduction processing. For example, processes such as removing sentence boundaries and punctuation marks may be included in preprocessing that occurs before vocabulary reduction processing. FIGS. 3-10 are flow diagrams that illustrate operations performed by various embodiments of the vocabulary reduction processing 210.

FIG. 3 includes a flow diagram of a process 300 according to some embodiments. In some embodiments, various hardware elements (e.g., a processor) of the system 100 execute program code to perform that process and/or the processes illustrated in other flow diagrams. The process and other processes mentioned herein may be embodied in processor-executable program code read from one or more non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, the above-mentioned corpus 110 is provided (i.e., stored and/or made accessible to and/or accessed by vocabulary reduction processing 210).

At S320, stemming is performed on the contents of the corpus 110. At this point the term “token” will be introduced. As used herein, “token” refers to a word in the corpus 110 or a string of characters output in the form of a word by a word tokenizer program. (Word tokenizers are known and are within the knowledge of those who are skilled in the art. The other preprocessing 212 of FIG. 2 may include a word tokenizer, which may operate on the corpus 110 prior to operation of the vocabulary reduction processing 210.) In some embodiments, the stemming may be performed using the well-known Snowball Stemmer In other embodiments, another known stemming algorithm may be used, such as the known Porter Stemmer or Lancaster Stemmer In some embodiments, stemming is applied to every token in the corpus 110. In some embodiments, stemming is applied to every unique token in the corpus 110. Thus, suffix manipulation is used to obtain a stem for at least some of the tokens in the corpus 110.

At S330, lemmas are obtained for at least some of the tokens in the corpus 110. This may involve using a known lemmatizer, such as a WordNet lemmatizer. The lemmas obtained at S330 are not necessarily selected for use in place of the respective tokens, as will be understood from subsequent discussion.

At S340, groups of tokens are formed. In some embodiments, the grouping of tokens may be based entirely on the respective stems to which the tokens are mapped. In other embodiments, other information may be used to form the groups of tokens in addition to using the respective stems for the tokens. In some embodiments, not all of the tokens are included in the groups formed at S340. In other embodiments, every token may be included in a group. In some embodiments, no token is assigned to more than one group.

At S350, lemmas are selected for at least some of the tokens included in the groups formed at S340. The groups of tokens may be used in the selection of lemmas. In some embodiments, characteristics of the lemmas that were obtained at S330 are used to select a lemma to which all tokens in a group are mapped. In some embodiments, different lemmas may be selected for different tokens within a given group. In some embodiments, each token is mapped to no more than one lemma at S350.

At S360, each token for which a lemma is selected at S350 is replaced in the corpus 110 (or in an image of the corpus 110) with the lemma that was selected for that token at S350.

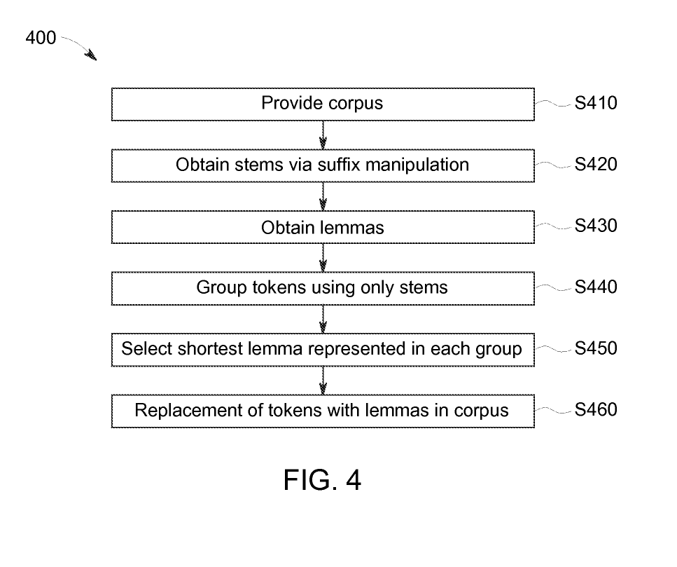

FIG. 4 includes a flow diagram of a process 400 according to some embodiments. S410 in FIG. 4 may be the same as S310 in FIG. 3. S420 in FIG. 4 may be the same as S320 in FIG. 3. S430 in FIG. 4 may be the same as S330 in FIG. 3.

At S440 in FIG. 4, groups of tokens are formed. In some embodiments, the groups are formed such that all of the tokens in each group share a stem. Tokens will be considered to “share a stem” if they were mapped to the same stem at S420. In some embodiments, every token that shares a particular stem is assigned to the same group and to no other group.

At S450, lemmas are selected for the tokens that were assigned to the groups formed at S440. In some embodiments, the vocabulary reduction processing 210 considers, for each group, the lemmas that were obtained at S430 for the tokens assigned to that group. In some embodiments, for each group, the vocabulary reduction processing 210 selects the (or a) lemma that is shortest in length (number of characters) among the lemmas that were obtained at S430 for the tokens assigned to that group. The selected lemma is deemed selected for every token assigned to the group, according to S450. A lemma that is obtained at S430 for a particular token will be considered to “correspond” to that token. At S450, by selecting the shortest lemma that corresponds to a token in the group, the vocabulary reduction processing 210, for at least some groups of tokens, selects among a plurality of lemmas that correspond to tokens in the particular group.

At S460, each token for which a lemma is selected at S450 is replaced in the corpus 110 (or in an image of the corpus 110) with the lemma that was selected for that token at S450.

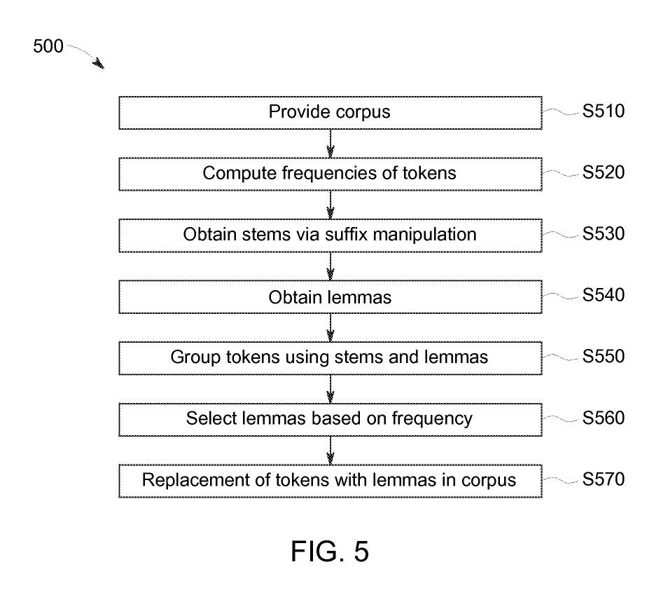

FIG. 5 includes a flow diagram of a process 500 according to some embodiments. S510 in FIG. 5 may be the same as S310 in FIG. 3. At S520 in FIG. 5, the vocabulary reduction processing 210 computes a frequency of each unique token in the corpus 110. This may be done, for example, for each unique token by counting how many times it appears in the corpus 110. S530 in FIG. 5 may be the same as S320 in FIG. 3.

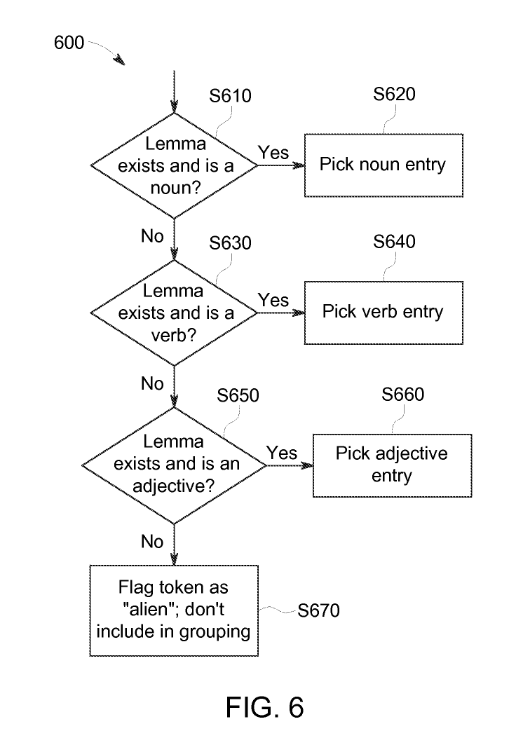

At S540 in FIG. 5, lemmas are obtained for at least some of the tokens in the corpus 110. This may involve using a known lemmatizer, such as a WordNet lemmatizer. The lemmas obtained at S540 are not necessarily selected for use in place of the respective tokens, as will be understood from subsequent discussion. In some embodiments, a precedence-scheme may be employed in obtaining lemmas at S540. The precedence-scheme may vary depending on characteristics of the corpus 110. FIG. 6 illustrates a precedence-scheme that may be used as part of S540 in some embodiments, and may be suitable for example if the corpus 110 were made up of engineering service logs or the like. Thus FIG. 6 may illustrate details of S540 according to some embodiments.

FIG. 6 includes a flow diagram of a process 600 according to some embodiments. At S610 in FIG. 6, a determination is made as to whether, for a unique token currently under consideration at S540, there exists a lemma in the dictionary and the lemma is a noun. If such is the case, then the process 600 may advance from S610 to S620. At S620, the noun dictionary entry in question is obtained as a lemma for the unique token currently under consideration (such token also being referred to as the “current unique token”).

If a negative determination is made at S610 (i.e., if it is determined at S610 that a noun lemma does not exist in the dictionary for the current unique token), then the process 600 may advance from S610 to S630. At S630, a determination is made as to whether, for the current unique token, there exists a lemma in the dictionary and the lemma is a verb. If such is the case, then the process 600 may advance from S630 to S640. At S640, the verb dictionary entry in question is obtained as a lemma for the current unique token.

If a negative determination is made at S630 (i.e., if it is determined at S630 that a verb lemma does not exist in the dictionary for the current unique token), then the process 600 may advance from S630 to S650. At S650, a determination is made as to whether, for the current unique token, there exists a lemma in the dictionary and the lemma is an adjective. If such is the case, then the process 600 may advance from S650 to S660. At S660, the adjective dictionary entry in question is obtained as a lemma for the current unique token.

If a negative determination is made at S650 (i.e., if it is determined at S650 that an adjective lemma does not exist in the dictionary for the current unique token), then the process 600 may advance from S650 to S670. At S670, the current unique token may have applied to it a label such as “alien”, meaning in this context that no lemma will be obtained for the current unique token (i.e., the current unique token will be excluded from lemmatization), and also the current unique token will be excluded from the grouping of tokens that is to come. (The subsequent grouping, in some embodiments, will include only tokens for which tokens are obtained at S540, FIG. 5, as implemented in accordance with the process 600 of FIG. 6.) Thus the process 600 of FIG. 6 will be seen as implementing a noun-verb-adjective-or-nothing precedence-scheme, which as noted before may be suitable for a corpus such as engineering service logs. Those who are skilled in the art will recognize that suitable precedence-schemes may be devised for preprocessing other types of corpuses. In some embodiments, no precedence-scheme may be used, and instead a conventional lemmatization may occur as via the above-mentioned WordNet process.

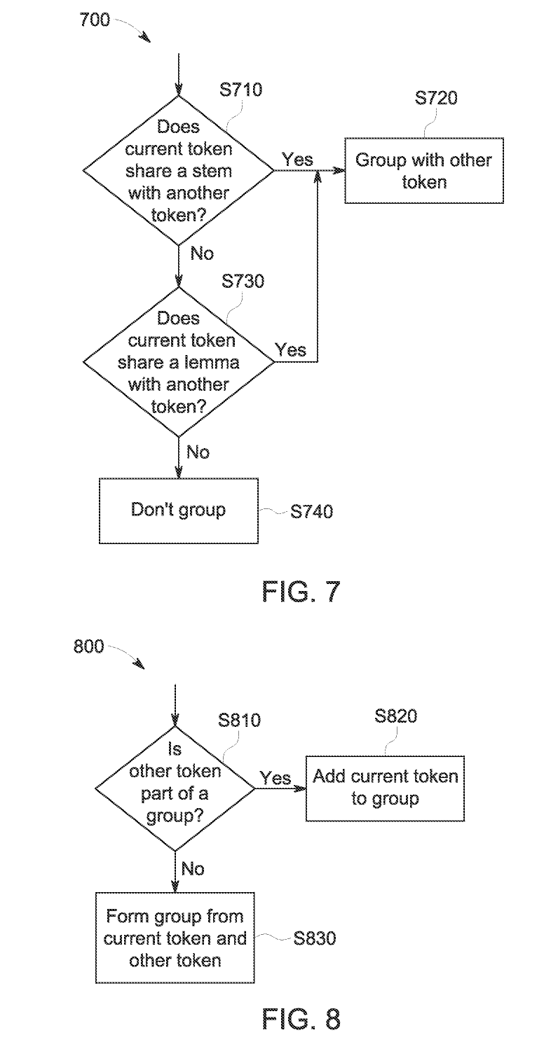

Referring again to FIG. 5, at S550, groups of tokens are formed. In some embodiments, both stems formed at S530 and lemmas obtained at S540 may be taken into consideration in forming the groups. FIG. 7 illustrates a manner in which S550 may be performed. Thus FIG. 7 may illustrate details of S550 according to some embodiments.

FIG. 7 includes a flow diagram of a process 700 according to some embodiments. It should be noted that the process 700 may be applied only to tokens not labeled as “alien” at S670. The process 700 may be applied to every token not labeled as “alien”.

At S710 in FIG. 7, a determination is made for a current token under consideration as to whether it shares a stem with any other token in the corpus 110. If so, the process 700 may advance from S710 to S720. At S720, the current token is placed in a group with the “other” token. Details of S720, according to some embodiments, are illustrated in FIG. 8. FIG. 8 includes a flow diagram of a process 800 according to some embodiments.

At S810 in FIG. 8, a determination is made as to whether the “other” token is already included in a group. If so, the process 800 may advance from S810 to S820. At S820, the current token is added to the group to which the “other” token belongs. If a negative determination is made at S810 (i.e., if it is determined that the “other” token is not already part of a group), then the process 800 may advance from S810 to S830. At S830, a group is formed consisting of the current token and the “other” token.

Reference will now be made again to FIG. 7, and particularly to S710. If a negative determination is made at S710 (i.e., if the current token is not found to share a stem with another token), then the process 700 may advance from S710 to S730.

At S730 in FIG. 7, a determination is made for the current token as to whether it shares a lemma with any other token in the corpus 110. (Two tokens will be deemed to “share a lemma” if the same lemma was obtained for both tokens at S540.) If the determination at S730 is affirmative (i.e., lemma shared by current token and other token), the process 700 may advance from S730 to S720, which was described above, particularly with reference to process 800. That is, the current token is grouped with the other token in this situation.

Continuing to refer to FIG. 7, if a negative determination is made at S730 (i.e., if the current token is not found to share a lemma with another token), then the process 700 may advance from S730 to S740. At 740, the vocabulary consolidation processing 210 notes that the current token is not to be grouped with any other token. Those who are skilled in the art will recognize that an outcome of S550 (FIG. 5), as described above in conjunction with FIGS. 7 and 8, is that for each group of tokens, each token in the particular group shares a stem or a lemma with at least one other token in the group.

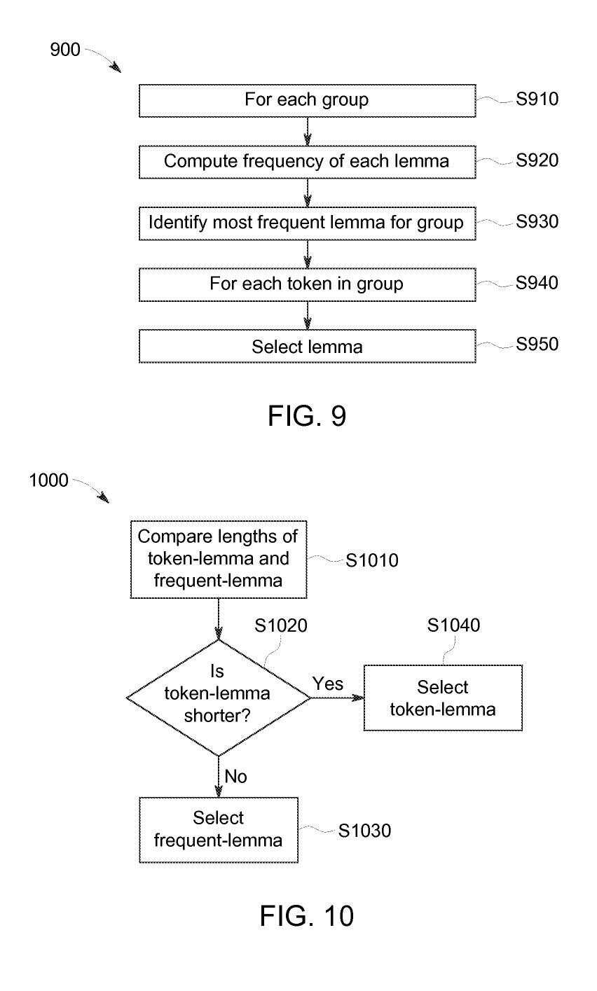

Referring again to FIG. 5, at S560, lemmas are selected for the tokens that were assigned to the groups formed at S550. In some embodiments, the vocabulary reduction processing 210 considers, for each group, the lemmas that were obtained at S540 for the tokens assigned to that group. In some embodiments, the vocabulary reduction processing 210 considers frequencies of the lemmas, as described below in connection with FIGS. 9 and 10. In some embodiments, the vocabulary reduction processing 210 also considers lengths of the lemmas, as particularly described below in connection with FIG. 10.

FIG. 9 illustrates a manner in which S560 may be performed. Thus FIG. 9 may illustrate details of S560 according to some embodiments.

FIG. 9 includes a flow diagram of a process 900 according to some embodiments. S910 in FIG. 9 indicates that the following process steps are to be performed for each group of tokens formed at S550 (FIG. 5). Continuing to refer to FIG. 9, at S920, the frequency is computed for each lemma represented in the current group. A lemma will be deemed “represented” in a group if there is at least one token in the group that (at S540) was mapped to the lemma in question. The computation of the frequency for a lemma may include summing the respective frequencies (as computed at S520) of each of the tokens mapped to the lemma in question.

At S930, the vocabulary reduction processing 210 identifies the most frequently occurring lemma in that group (i.e., the lemma represented in the current group that has the largest frequency as computed at S920).

Block S940 in FIG. 9 indicates that the balance of the process is to be performed for each token included in the current group. The balance of the process (per token, per group) is represented at S950 in FIG. 9. At S950, a lemma is selected for the current token in the current group. Details of S950, according to some embodiments, are illustrated in FIG. 10. FIG. 10 includes a flow diagram of a process 1000 according to some embodiments.

At S1010 in FIG. 10, the length of the most frequent lemma for the current group, as identified at S930 (which lemma may hereinafter sometimes be referred to as the “frequent-lemma”) is compared with the length of the lemma obtained at S540 for the current token (which lemma may hereinafter sometimes be referred to as the “token-lemma”).

At S1020, a determination is made as to whether the length of the token-lemma is shorter than the length of the frequent-lemma. If not, the process 1000 may advance from S1020 to S1030. At S1030, the frequent-lemma is selected for the current token. However, if a positive determination is made at S1020 (i.e., if it is determined that the token-lemma is shorter than the frequent-lemma), then the process 1000 may advance from S1020 to S1040. At S1040, the token-lemma is selected for the current token. Thus, at S950, as illustrated in FIG. 10, the vocabulary reduction processing 210 selects between the frequent-lemma and the token-lemma for each token in a current group, and does so for each group of tokens.

In some embodiments, as an alternative to the process of FIG. 10, the vocabulary reduction processing 210 may select the frequent-lemma for each token in the group in question.

Referring again to FIG. 5, at S570, each token for which a lemma is selected at S560 is replaced in the corpus 110 (or in an image of the corpus 110) with the lemma that was selected for that token at S560.

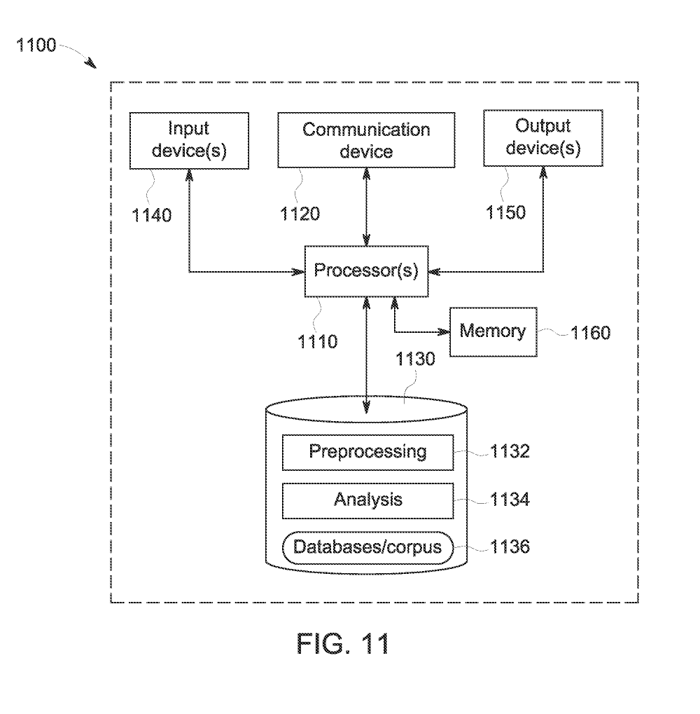

System 1100 shown in FIG. 11 is an example hardware-oriented representation of the system 100 shown in FIG. 1. Continuing to refer to FIG. 11, system 1100 includes one or more processors 1110 operatively coupled to communication device 1120, data storage device 1130, one or more input devices 1140, one or more output devices 1150 and memory 1160. Communication device 1120 may facilitate communication with external devices, such as a reporting client, or a data storage device. Input device(s) 1140 may include, for example, a keyboard, a keypad, a mouse or other pointing device, a microphone, knob or a switch, an infra-red (IR) port, a docking station, and/or a touch screen. Input device(s) 1140 may be used, for example, to enter information into the system 1100. Output device(s) 1150 may include, for example, a display (e.g., a display screen) a speaker, and/or a printer.

Data storage device 1130 may include any appropriate persistent storage device, including combinations of magnetic storage devices (e.g., magnetic tape, hard disk drives and flash memory), optical storage devices, Read Only Memory (ROM) devices, etc., while memory 1160 may include Random Access Memory (RAM).

Data storage device 1130 may store software programs that include program code executed by processor(s) 1110 to cause system 1100 to perform any one or more of the processes described herein. Embodiments are not limited to execution of these processes by a single apparatus. For example, the data storage device 1130 may store a preprocessing software program 1132 that provides functionality corresponding to the preprocessing functionality 112 referred to above in connection with FIG. 1. The preprocessing software program may provide one or more embodiments of vocabulary reduction algorithms such as those described above with reference to FIGS. 3-10.

Data storage device 1130 may also store a text analysis software program 1134, which may correspond to the analytical/text mining functionality 116 referred to above in connection with FIG. 1. Further, data storage device 1130 may store one or more databases and/or corpuses 1136, which may include the corpus 110 referred to above in connection with FIG. 1. Data storage device 1130 may store other data and other program code for providing additional functionality and/or which are necessary for operation of system 1100, such as device drivers, operating system files, etc.

A technical effect is to provide improved preprocessing of text corpuses that are to be the subject of data mining or similar types of machine analysis.

An advantage of the vocabulary reduction algorithms disclosed herein is that a degree of reduction comparable to that achieved by conventional stemming algorithms may be combined with output of base-forms that are lemmas and thus are recognizable dictionary words. So the algorithms disclosed herein may synergistically combine the benefits of both suffix manipulation and lemmatization in one vocabulary reduction algorithm.

Moreover, the frequency-based lemma selection as described with reference to FIGS. 5-10 may make use of domain-specific (i.e., corpus- or corpus-type-specific) information that is reflected in the word frequencies.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. A person of ordinary skill in the relevant art may recognize other embodiments may be practiced with modifications and alterations to that described above.

What is claimed is:

1. A method, comprising:
providing a corpus of text;
using suffix manipulation to obtain a stem for at least some tokens in the corpus;
using the respective stem for each token of said at least some tokens to form groups of said at least some tokens; and
using said groups of tokens to select lemmas for at least some of the tokens in said groups.

2. The method of claim 1, further comprising:
replacing, in the corpus, each of at least some of the tokens included in said groups of tokens with the selected lemma for said each token.

3. The method of claim 1, wherein:
the step of using said groups of tokens includes, for each of at least some of said groups, selecting among a plurality of lemmas that correspond to tokens in said each group.

4. The method of claim 3, wherein:
said selecting among a plurality of lemmas includes selecting a shortest one of said lemmas.

5. The method of claim 3, wherein:
said selecting among a plurality of lemmas includes selecting a one of said plurality of lemmas that has a larger frequency than any other lemma of said plurality of lemmas.

6. The method of claim 1, wherein:
for each of said groups of tokens, all of the tokens in said each group share a stem.

7. The method of claim 1, wherein:
for each of said groups of tokens, each of the tokens in said each group of tokens shares a stem or a lemma with at least one other token in said group of tokens.

8. The method of claim 1, wherein the step of using suffix manipulation includes using a stemming algorithm selected from the group consisting of: (a) the Snowball Stemmer; (b) the Porter Stemmer; and (c) the Lancaster Stemmer.

9. An apparatus, comprising:
a processor; and
a memory in communication with the processor, the memory storing program instructions, the processor operative with the program instructions to perform functions as follows:
providing a corpus of text;
using suffix manipulation to obtain a stem for at least some tokens in the corpus;
using the respective stem for each token of said at least some tokens to form groups of said at least some tokens; and
using said groups of tokens to select lemmas for at least some of the tokens in said groups.

10. The apparatus of claim 9, wherein the processor is further operative with the program instructions to replace, in the corpus, each of at least some of the tokens included in said groups of tokens with the selected lemma for said each token.

11. The apparatus of claim 9, wherein the function of using said groups of tokens, includes, for each of at least some of said groups, selecting among a plurality of lemmas that correspond to tokens in said each group.

12. The apparatus of claim 11, wherein the function of selecting among a plurality of lemmas includes selecting a shortest one of said lemmas.

13. The apparatus of claim 11, wherein said function of selecting among a plurality of lemmas includes selecting a one of said plurality of lemmas that has a larger frequency than any other lemma of said plurality of lemmas.

14. The apparatus of claim 9, wherein for each of said groups of tokens, all of the tokens in said each group share a stem.

15. The apparatus of claim 9, wherein for each of said groups of tokens, each of the tokens in said each group of tokens shares a stem or a lemma with at least one other token in said group of tokens.

16. A method, comprising:
(a) providing a corpus of text;
(b) computing a frequency of each unique token in the corpus;
(c) using suffix manipulation to obtain a stem for each unique token in the corpus;
(d) using a dictionary to obtain a lemma for at least some of the tokens in the corpus;
(e) forming groups of said at least some tokens, such that for each of said groups of tokens, each of the tokens in said each group of tokens shares a stem or a lemma with at least one other token in said group of tokens; and
(f) for each of said groups of tokens:
(i) computing a frequency of each lemma represented in said each group of tokens;
(ii) identifying a most frequently occurring lemma in said each group; and
(iii) for each token in said each group, selecting between said lemma obtained at step (d) and said identified most frequently occurring lemma for said each group.

17. The method of claim 16, wherein said selecting at step (f) (iii) includes comparing a length of said lemma obtained at step (d) with a length of said identified most frequently occurring lemma for said each group.

18. The method of claim 17, wherein said selecting at step (f) (iii) includes selecting a shorter one of said lemma obtained at step (d) and said identified most frequently occurring lemma for said each group.

19. The method of claim 16, wherein said obtaining lemmas at step (d) is based on respective parts of speech represented by dictionary entries that correspond to said at least some tokens.

20. The method of claim 16, wherein:
said step (f)(i) includes summing respective frequencies of each token mapped to said each lemma.
